(19) United States
(12) Patent Application Publication
(10) Pub. No.: US 2009/0096427 A1
(43) Pub. Date: Apr. 16, 2009

(54) Apparatus for detecting end-of-charge for a battery charger

(75) Inventor: Ken Yang, Tunstin, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 12/153,075

(22) Filed: May 13, 2008

Related U.S. Application Data
(60) Provisional application No. 60/960,705, filed on Oct. 10, 2007.

(51) Int. Cl. H02J 7/00

(52) U.S. Cl. 320/162

(57) ABSTRACT

An apparatus and method for accurate end-of-charge (EOC) detection in a battery charger is provided. An EOC circuit determines that a battery has been fully charged when two conditions are met. The first condition for EOC detection is that the battery has reached a predetermined voltage and, as a result, the battery charger has transitioned to a constant voltage phase of the charging process. The second condition for EOC detection is that the battery current has fallen below a predetermined, set level. When both of these conditions are met, EOC is detected. This bi-condition EOC detection scheme is capable of accurate EOC detection, i.e. determining when the battery is fully charged.

### CROSS REFERENCE TO RELATED APPLICATIONS

This patent application claims the benefit of U.S. Provisional Patent Application No. 60/960,705 (Attorney Docket No. 2875.2070000), filed Oct. 10, 2007, entitled “Apparatus for Detecting End-of-Charge for a Battery Charger,” which is incorporated herein by reference in its entirety.

### BACKGROUND OF THE INVENTION

The present invention generally relates to charging a battery, and more particularly to a method and apparatus for end-of-charge detection during charging of a battery.

The increased demand for portable devices has highlighted the need for more efficient batteries and battery chargers. As a result, battery chemistries, including the more popular lithium and nickel based batteries, have seen marked improvements in performance. Although batteries continue to improve, much of their potential remains dependent on the battery charger. Accordingly, the battery charger must keep pace with battery technology in order to realize the full capabilities of such batteries.

Several different types of rechargeable batteries are commonly used, including lithium and nickel based batteries. Lithium-ion (Li-ion) batteries are found in many of today's portable devices. Comparatively, Li-ion batteries provide a high energy-to-weight ratio (i.e., energy density) and slow loss of charge when not in use. However, Li-ion batteries and other battery types deteriorate when charged beyond a rated voltage, experiencing reduced performance and life. The rated voltage is the maximum recommended voltage for charging the battery (e.g., 4.2 V typically for Li-ion batteries) and is often dependent on the design parameters of the battery. As a result, it is beneficial for battery chargers to be capable of accurate end-of-charge (EOC) detection to prevent over charging the battery.

Prior art EOC detection typically varies depending on the type of battery charger. The most common battery chargers found in today's battery powered devices include linear chargers, switch-mode chargers, and pulse chargers. Linear chargers are generally the simplest and smallest of the three, but suffer from high inefficiency. Switch-mode chargers, in contrast to linear chargers, are relatively efficient, at the cost of higher complexity and size. Pulse chargers are fairly new compared to linear and switch-mode chargers and share many of the benefits associated with both of these designs, i.e. high efficiency and low complexity. However, pulse chargers are not without cost, often requiring a more complex adapter that provides a current-limited supply of power.

In linear and switch-mode chargers EOC detection is normally based on sensing a charging current through a resistor. The charging current is shared between a system load current and a battery current. As the charging current through the resistor falls below a set level (e.g., 50 mA), EOC is detected. This technique works well if the system load current is small compared to the set level for detecting EOC. However, if the system load current is greater than this set level, EOC may never be detected, and the charger may continue to charge the battery indefinitely. Keeping the battery at a high charging voltage, typical set at or near the voltage rating of the battery, may degrade battery life and performance.

In pulse chargers, EOC detection is normally based on criteria similar to that of linear and switch mode chargers. Pulse charging, in general, charges a battery by switching a constant current source to the battery on and off. By measuring the duty-cycle in which the constant current source is switched to the battery, the average charging current may be determined. Therefore, the duty-cycle is typically used to determine when the average charging current falls below a set level (e.g., 10%), signifying EOC. As mentioned above, the charging current is often shared between a system load current and a battery current. Consequently, this technique works well if the system load current is small compared to the set level for detecting EOC. However, if the system load current is greater than this set level, EOC may never be detected, and the charger may continue to charge the battery indefinitely.

In applications such as cell phones and laptop computers, the battery is often being charged while the system is operating. Thus, the load current may be relatively high. Under these conditions, prior art EOC detection for linear, switch-mode, and pulse chargers is difficult, inaccurate, or impossible.

Thus, what is needed is an apparatus and method for EOC detection that overcomes the shortcomings described above. Further aspects and advantages of this invention will become apparent from the detailed description that follows.

### BRIEF DESCRIPTION OF THE DRAWINGS/FIGURES

The accompanying drawings illustrate the present invention and, together with the description, further serve to explain the principles of the invention and to enable one skilled in the pertinent art to make and use the invention.

FIG. 1 is a simplified block diagram of an exemplary battery charging system.

FIG. 2 is a schematic diagram of an exemplary embodiment of a linear charger in accordance with the present invention.

FIG. 3 is a schematic diagram of an exemplary embodiment of a switch-mode charger in accordance with the present invention.

FIG. 4 is a schematic diagram of an exemplary embodiment of a pulse charger in accordance with the present invention.

FIG. 5 illustrates an exemplary charging operation performed by a pulse charger, such as the pulse charger shown in FIG. 4, according to an embodiment of the present invention.

FIG. 6 is a process flow chart of a method for charging a battery and performing end-of-charge detection in a pulse charger, such as the pulse charger shown in FIG. 4, according to an embodiment of the present invention.

The present invention will now be described with reference to the accompanying drawings. In the drawings, like reference numbers generally indicate identical or functionally similar elements. The drawing in which an element first appears is indicated by the leftmost digit(s) in the reference number.

### DETAILED DESCRIPTION OF THE INVENTION

The following detailed description of the present invention refers to the accompanying drawings that illustrate exemplary embodiments consistent with this invention. Other embodiments are possible, and modifications may be made to the embodiments within spirit and scope of the invention. Therefore, the detailed description is not meant to limit the invention. Rather, the scope of the invention is defined by the appended claims.

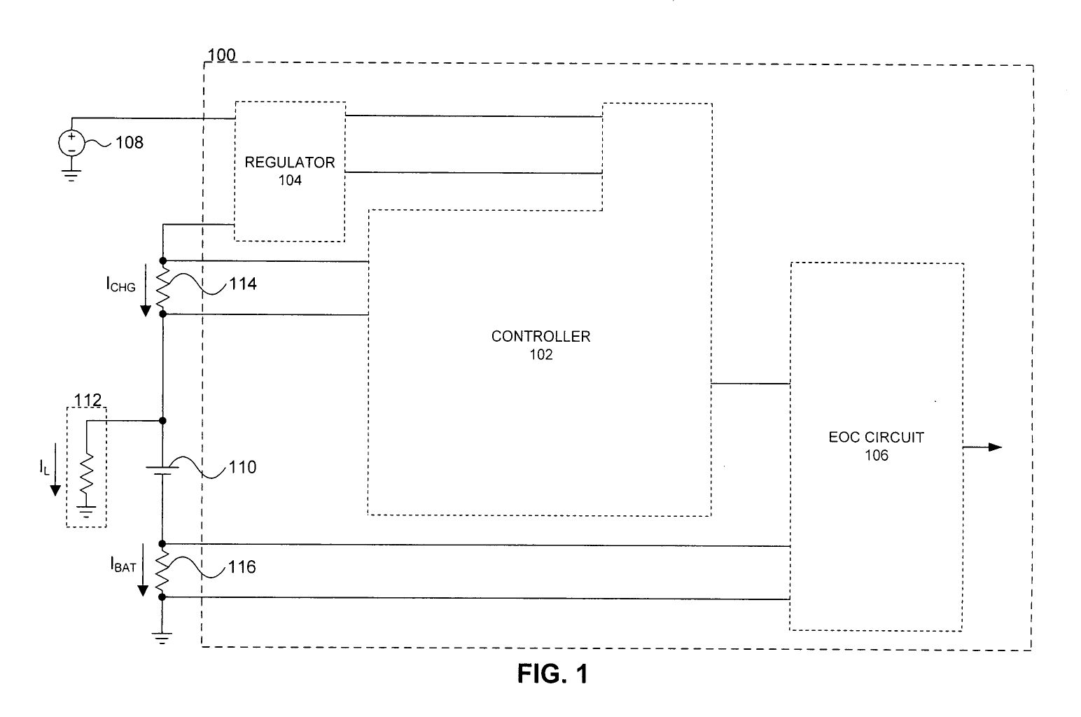

FIG. 1 provides a diagram of an example battery charger 100, according to an embodiment of the invention. A battery charger, such as battery charger 100, processes an input power signal to provide a charging current/voltage to a battery. Battery charger 100 can monitor and control the charging current/voltage provided to a battery and accurately detect when end-of-charge (EOC) occurs, i.e. when the battery is fully charged.

Battery charger 100 includes controller 102, regulator 104, and EOC circuit 106. Regulator 104 receives an input power signal from adapter 108 that can be used to charge battery 110. The charging current I_{CHG} provided by regulator 104 is shared between battery 110 and load 112. Although simply shown as a resistor, representative load 112 may be a portable communications device or other battery powered device.

Regulator 104 is coupled to controller 102 that monitors the charging current I_{CHG} and charging voltage applied across battery 110. Controller 102 is configured to adjust the charging current I_{CHG} provided to battery 110 by controlling regulator 104. In typical battery chargers, the charging process includes two phases, a constant current (CC) phase and a constant voltage (CV) phase. At the beginning of a full-charge cycle, when the battery voltage is low, the charging process begins in the CC phase and charges battery 110 with a constant current. The charging current I_{CHG} is monitored by controller 102, which then subsequently controls regulator 104 to maintain the charging current I_{CHG}, or the average charging current I̅_̅{̅C̅H̅G̅}̅, at a constant, predetermined level. When the battery voltage reaches a predetermined value V_{MAX} that is typically set at or near the voltage rating of the battery (e.g., 4.2 V in common Li-ion batteries), then the charging process transitions from the CC phase to the CV phase.

While in the CV phase of the charging process, battery charger 100 maintains the charging voltage applied to battery 110 at the predetermined value V_{MAX}. Controller 102 monitors the charging voltage and adjusts regulator 104 to maintain the charging voltage, or the average charging voltage, at the constant, predetermined value V_{MAX}.

In conventional linear and switch-mode chargers, the charging process would remain in the CV phase until the charging current I_{CHG} falls below a set level (e.g., 50 mA), signifying EOC. However, as can be seen from FIG. 1 the charging current I_{CHG} is generally shared between battery 110 and load 112. Consequently, when the load current I_{L} is high, the charging current I_{CHG} may never fall below the trip level (i.e., the set level) used to signify EOC. As a result, the charging process may continue to charge battery 110 indefinitely. Continuing to charge battery 110 after the battery has been fully charged can deteriorate battery performance and life.

In conventional pulse chargers, the charging process would similarly remain in a pulse-mode until the duty-cycle of the pulses falls below a set level, signifying EOC. However, as mentioned above, if the load current I_{L} is relatively high compared to the set level for detecting EOC, then the duty-cycle may never fall below the set level. As a result, the charging process may continue to charge battery 110 indefinitely. Continuing to charge battery 110 after the battery has been fully charged can deteriorate battery performance and life.

The focus of the present invention relates primarily to a new method and apparatus for detecting EOC that overcomes the limitations of previous EOC detection schemes, such as the limitations mentioned above. In particular, the present invention relates primarily to EOC circuit 106 and the components within EOC circuit 106. EOC circuit 106 determines that battery 110 has been fully charged when two conditions are met. The first condition for EOC detection is that battery 110 has reached a predetermined value V_{MAX} and, as a result, the charger has transitioned to the CV phase of the charging process. The second condition for EOC detection is that the battery current I_{BAT} has fallen below a set level (e.g. 50 mA). When both of these conditions are met, EOC is detected. This bi-condition EOC detection scheme is capable of accurate EOC detection, i.e. determining when battery 110 is fully charged.

The battery current I_{BAT} is monitored by EOC circuit 106 using a small sense resistor 116 in series with the negative terminal of battery 110 and ground. The sense resistor 116 is typically very small to reduce the voltage drop across its terminals, which in turn keeps the power dissipation to a minimum. In using sense resistor 116 to detect the battery current I_{BAT}, EOC may be accurately detected. The battery current I_{BAT}, unlike the charging current I_{CHG}, is not dependent on the load current I_{L}. As a result, the battery current I_{BAT} provides a more accurate representation of the charging state of battery 110, regardless of the load current I_{L}.

Battery charger 100 is described by way of example, and not limitation. The use of other battery chargers is possible without departing from the spirit and scope of the present invention. In the following section, exemplary embodiments of linear, switch-mode, and pulse chargers are presented that implement an EOC detection apparatus and method in accordance with the present invention.

### Linear Charger

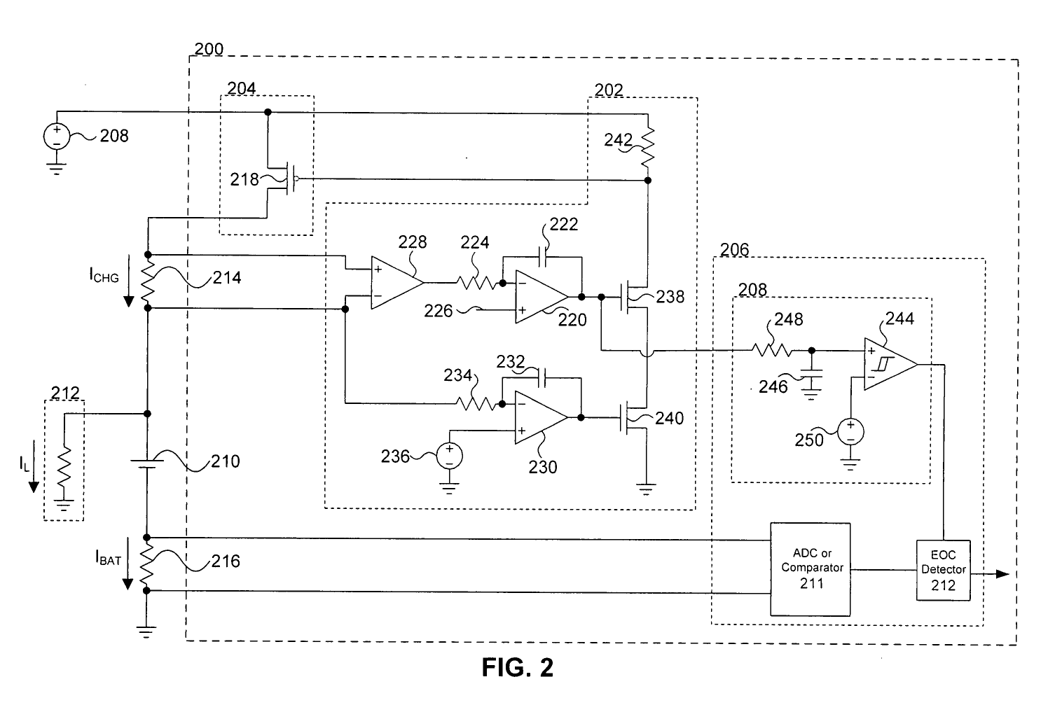

FIG. 2 is a schematic diagram of an exemplary embodiment of a linear charger 200 in accordance with the present invention. Linear charger 200 is configured to recharge battery 210 that supplies power to representative load 212. Although simply shown as a resistor, representative load 212 may be a portable communications device or other battery powered device. Linear charger 200 can monitor and control the charging current/voltage provided to a battery and accurately detect when end-of-charge (EOC) occurs, i.e. when the battery is fully charged.

The linear charger 200 has a controller 202 in communication with a regulator 204. The regulator 204 is coupled to an adapter 208 and a resistor 214. The controller 202 controls the regulator 204 to supply various levels of charging current I_{CHG} and/or charging voltage to battery 210. For instance, controller 202, during the initial CC phase of the charging process, maintains a constant charging current I_{CHG} to battery 210 and representative load 212. Controller 202 can monitor the charging current I_{CHG} flowing through resistor 214 and adjust the regulator accordingly. In an embodiment, battery 210 is a Li-ion type battery and the set level for the constant charging current I_{CHG} is 100 mA.

The approximate voltage across the terminals of battery 210 may further be monitored by controller 202, at the bottom terminal of resistor 214, to determine when the charging process should transition from the CC phase to the CV phase. In general, controller 202 transitions from the CC phase to the CV phase when the battery voltage rises to a specified limit V_{MAX}, which is typically the rated voltage of battery 210 (e.g. 4.2 V in common Li-ion batteries). The charging process does not end until the EOC circuitry 206 signals that battery 210 has been fully charged.

Regulator 204 includes a transistor, such as PMOS transistor 218 shown in FIG. 2. PMOS transistor 218 is capable of regulating the charging current I_{CHG} or voltage provided to battery 210 and load 212. Controller 202 provides a control signal that is coupled to the gate of PMOS transistor 218. PMOS transistor 218 is generally maintained in its linear operating region and functions to drop the adapter voltage down to the battery voltage. Depending on the control voltage applied to the gate of PMOS transistor 218, the charging current I_{CHG} or voltage may be regulated to a desired value. Regulator 204 is described by way of example, and not limitation. The use of other implementations of regulator 204 is possible without departing from the spirit and scope of the present invention. For instance, regulator 204 may consist of a bipolar junction transistor in place of PMOS transistor 218 as shown. In addition, regulator 204 may comprise additional components not shown within FIG. 2.

Controller 202 includes means to monitor the charging current I_{CHG} and/or the charging voltage. In some instances, the average charging current I̅_̅{̅C̅H̅G̅}̅ and/or the average charging voltage may be monitored. As shown in FIG. 2, controller 202 comprises a CC loop integrator and a CV loop integrator that provide an indication of the average charging current I̅_̅{̅C̅H̅G̅}̅ and average charging voltage, respectively. The CC loop integrator includes amplifier 220, capacitor 222, resistor 224, and current setting input 226. The CC loop integrator integrates the charging current I_{CHG} output by differential amplifier 228. Differential amplifier 228 is connected to both terminals of resistor 214. By measuring the voltage drop across resistor 214, the charging current I_{CHG} may be determined by differential amplifier 228. The CC loop integrator integrates the charging current I_{CHG} and adjusts the gate voltage of NMOS transistor 238 to maintain the average charging current I̅_̅{̅C̅H̅G̅}̅ at a desired level set by current setting input 226. An example voltage applied to current setting input 226 may maintain the average charging current I̅_̅{̅C̅H̅G̅}̅ at 100 mA during the CC phase of the charging process, but other voltage values may be applied to current setting input 226 to achieve other constant current values.

The CV loop integrator of controller 202 consists of amplifier 230, capacitor 232, resistor 234, and reference voltage 236. The charging voltage is measured from the top terminal of battery 210, which is coupled to the inverting input of amplifier 230 via resistor 234. The CV loop integrator integrates the charging voltage and adjusts the gate voltage of NMOS transistor 240 to maintain the average charging voltage at a desired level set by reference voltage 236. An example value for reference voltage 236 may maintain the charging voltage at 4.2 V during the CV phase of the charging process, but other voltage values for reference voltage 236 may be used to achieve other constant charging voltages.

At the beginning of a full charge cycle, when the battery voltage is low, the CC loop integrator dominates control of regulator 218. The CC loop integrator adjusts the gate voltage of NMOS transistor 238 such that a constant charging current I_{CHG}, or average charging current I̅_̅{̅C̅H̅G̅}̅, is maintained. As the battery voltage rises to a predetermined value V_{MAX}, typically set at the voltage rating of battery 210, the CV loop begins to take control of regulator 218. During the CC phase of the charging process, when the battery voltage is low, the CV integrator drives NMOS transistor 240 to be fully on or nearly fully on. As the battery voltage rises and reaches the predetermined value V_{MAX}, the CV loop begins to dominate control of regulator 204. The gate voltage of transistor 240 is controlled by the CV integrator to maintain the average charging voltage at the predetermined value V_{MAX}. Resistor 242 forms a voltage divider with NMOS transistors 238 and 240 and allows NMOS transistors 238 and 240 to control regulator 204.

EOC circuit 206 includes CV loop detector 208, analog-to-digital converter 211, and EOC detector 212. CV loop detector 208 includes comparator 244, capacitor 246, resistor 248, and saturation reference voltage 250. Capacitor 246 and resistor 248 form a low-pass filter, the output of which is coupled to the non-inverting input of comparator 244. Saturation reference voltage 250 is coupled to the inverting input of comparator 244.

EOC circuit 206 determines that battery 210 has been fully charged when two conditions are met. The first condition for EOC detection is that battery 210 has reached a predetermined voltage V_{MAX} and, as a result, charger 200 has transitioned to the CV phase of the charging process. The second condition for EOC detection is that the battery current I_{BAT} has fallen below a predetermined, set level (e.g. 50 mA). When both of these conditions are met, EOC is detected. This bi-condition EOC detection scheme is capable of accurate EOC detection, i.e. determining when battery 210 is fully charged.

The first condition, that is the battery voltage has reached the predetermined voltage V_{MAX}, is detected by CV loop detector 208. In an embodiment, CV loop detector 208 is coupled to the output of the CC loop integrator. As mentioned earlier, as the charging process transitions from the CC phase to the CV phase, the CC loop integrator output has little or no effect on regulator 204. This is mainly because NMOS transistor 238 is pushed into saturation. By setting saturation reference voltage 250 at or near the saturation voltage of transistor 238, detector 208 may accurately determine when the charging process is or has entered the CV phase, i.e. when the CV loop begins to dominate control of regulator 204. If saturation reference voltage 250 is less than the filtered CC loop integrator output, the output of comparator 244 would be logically high, signifying that battery charger 200 is within the CV phase of the charging process. The low-pass filter formed by capacitor 246 and resistor 248 may be used to reduce bounce produced near the CC/CV phase transition boundary. CV loop detector 208 is coupled at an output to EOC detector 212 and signals to EOC detector 212 when the charging process is within the CV phase, the first condition for accurate EOC detection.

In another embodiment, CV loop detector 208 may be coupled to the output of the CV loop integrator. In this instance, saturation reference voltage 250 would be set equal to the predetermined voltage V_{MAX} (e.g. 4.2 V) in which the CV phase of the charging process primarily begins.

Analog-to-digital converter (ADC) 211 is capable of measuring the battery current I_{BAT} using a small sense resistor 216 in series with the negative terminal of battery 210 and ground. The sense resistor 216 is typically very small to reduce the voltage drop across its terminals, which in turn keeps the power dissipation to a minimum. In using sense resistor 216 to detect the battery current I_{BAT}, EOC may be accurately detected. The battery current I_{BAT}, unlike the charging current I_{CHG}, is not dependent on the load current I_{L}. As a result, the battery current I_{BAT} provides a more accurate representation of the charging state of battery 210, regardless of the load current I_{L}. ADC 211 may determine when the battery current I_{BAT} has fallen below the predetermined, set level necessary for EOC detection. ADC 211 is coupled at an output to EOC detector 212 to provide an indication of when the battery current I_{BAT} has fallen below the predetermined, set level.

In another embodiment, ADC 211 may be replaced by a comparator. The comparator may determine when the battery current I_{BAT} has fallen below the set level (e.g. 50 mA) and provide an indication of this to EOC detector 212 via an output signal as shown in FIG. 2.

EOC detector 212 determines that both conditions for EOC are met-battery charger 200 is the CV phase of the charging process, and the battery current I_{BAT} is less than the predetermined, set level. When both of these conditions are met, EOC detector 212 outputs a signal to indicate that the charging process has reached EOC.

### Switch-Mode Charger

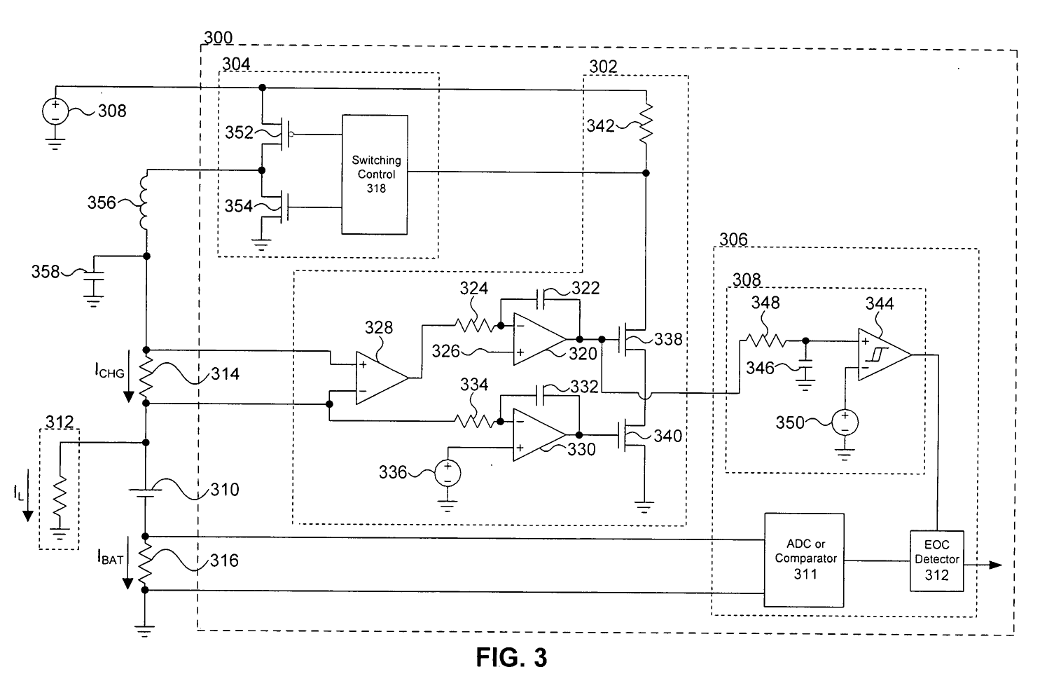

FIG. 3 is a schematic diagram of an exemplary embodiment of a switch-mode charger 300 in accordance with the present invention. Switch-mode charger 300 is configured to recharge battery 310 that supplies power to representative load 312. Although simply shown as a resistor, representative load 312 may be a portable communications device or other battery powered device. Switch-mode charger 300 can monitor and control the charging current/voltage provided to a battery and accurately detect when end-of-charge (EOC) occurs, i.e. when the battery is fully charged.

The switch-mode charger 300 has a controller 302 in communication with a regulator 304. The regulator 304 is coupled to an adapter 308. The controller 302 controls the regulator 304 to supply various levels of charging current I_{CHG} and/or charging voltage to battery 310. For instance, controller 302, during the initial CC phase of the charging process, maintains a constant charging current I_{CHG} to battery 310 and representative load 312. Controller 302 can monitor the charging current I_{CHG} flowing through resistor 314 and adjust the regulator accordingly. In an embodiment, battery 310 is a Li-ion type battery and the set level for the constant charging current I_{CHG} is 100 mA.

The approximate voltage across the terminals of battery 310 may further be monitored by controller 302, at the bottom terminal of resistor 314, to determine when the charging process should transition from the CC phase to the CV phase. In general, controller 302 transitions from the CC phase to the CV phase when the battery voltage rises to a specified limit V_{MAX}, which is typically the rated voltage of battery 310 (e.g. 4.2 V in common Li-ion batteries). The charging process does not end until the EOC circuitry 306 signals that battery 310 has been fully charged.

Regulator 304 includes switching control 318 and an output switch consisting of PMOS transistor 352 and NMOS transistor 354. Switching control 318 controls the timing in which transistors 352 and 354 are turned on and off (i.e., the duty cycle) to regulate the flow of power to battery 310 and load 312. Inductor 356 and capacitor 358, although shown separate, are generally considered a part of regulator 304. Inductor 356 and capacitor 358 are energy storage elements that convert the switched current pulses, produced by the switching of transistors 352 and 354, into a steady charging current I_{CHG}. Regulator 304 is commonly referred to as a switching regulator and is, in general, more efficient then the linear regulator used in the linear charger of FIG. 2. Transistors 352 and 354 are, for the most part, either fully on or fully off and, as a result, dissipate nearly zero power. Although regulator 304 is very efficient, regulator 304 is normally more costly and larger in size than regulators used in linear chargers, due in part to the external filter made up of inductor 356 and capacitor 358.

Depending on the control signal received by regulator 304 at switching control 318, the regulator may maintain the charging current I_{CHG} and/or the charging voltage at a desired level. Regulator 304 is described by way of example, and not limitation. The use of other implementation of regulator 304 is possible without departing from the scope of the present invention.

Controller 302 includes means to monitor the charging current I_{CHG} and/or the charging voltage. In some instances, the average charging current I̅_̅{̅C̅H̅G̅}̅ and/or the average charging voltage may be monitored. As shown in FIG. 3, controller 302 comprises a CC loop integrator and a CV loop integrator that provide an indication of the average charging current I̅_̅{̅C̅H̅G̅}̅ and average charging voltage, respectively. The CC loop integrator includes amplifier 320, capacitor 322, resistor 324, and current setting input 326. The CC loop integrator integrates the charging current I_{CHG} Output by differential amplifier 328. Differential amplifier 328 is connected to both terminals of resistor 314. By measuring the voltage drop across resistor 314, the charging current I_{CHG} may be determined by differential amplifier 328. The CC loop integrator integrates the charging current I_{CHG} and adjusts the gate voltage of NMOS transistor 338 to maintain the average charging current I̅_̅{̅C̅H̅G̅}̅ at a desired level set by current setting input 326. An example voltage applied to current setting input 326 may maintain the average charging current I̅_̅{̅C̅H̅G̅}̅ at 100 mA during the CC phase of the charging process, but other voltage values may be applied to current setting input 326 to achieve other constant current values.

The CV loop integrator of controller 302 includes amplifier 330, capacitor 332, resistor 334, and reference voltage 336. The charging voltage is measured from the top terminal of battery 310, which is coupled to the inverting input of amplifier 330 via resistor 334. The CV loop integrator integrates the average charging voltage and adjusts the gate voltage of NMOS transistor 340 to maintain the charging voltage at a desired level set by reference voltage 336. An example value for reference voltage 336 may maintain the charging voltage at 4.2 V during the CV phase of the charging process, but other voltage values for reference voltage 236 may be used to achieve other constant charging voltages.

At the beginning of a full charge cycle, when the battery voltage is low, the CC loop integrator dominates the control of regulator 318. The CC loop integrator adjusts the gate voltage of NMOS transistor 338 such that a constant charging current I_{CHG}, or the average charging current I̅_̅{̅C̅H̅G̅}̅, is maintained. As the battery voltage rises to a predetermined value V_{MAX}, typically set at the voltage rating of battery 310 (e.g. 4.2 V), the CV loop begins to take control of regulator 318. During the CC phase of the charging process, when the battery voltage is low, the CV integrator drives NMOS transistor 340 to be fully on or nearly fully on. As the battery voltage rises and reaches the predetermined value V_{MAX}, the CV loop begins to dominate the control of regulator 304. The gate voltage of transistor 340 is controlled by the CV integrator to maintain the charging voltage at the predetermined value V_{MAX}. Resistor 342 forms a voltage divider with NMOS transistors 338 and 340 and allows NMOS transistors 338 and 340 to control regulator 304.

EOC circuit 306 includes CV loop detector 308, analog-to-digital converter 311, and EOC detector 312. CV loop detector 308 includes comparator 344, capacitor 346, resistor 348, and saturation reference voltage 350. Capacitor 346 and resistor 348 form a low-pass filter, the output of which is coupled to the non-inverting input of comparator 344. Saturation reference voltage 350 is coupled to the inverting input of comparator 344.

EOC circuit 306 determines that battery 310 has been fully charged when two conditions are met. The first condition for EOC detection is that battery 310 has reached a predetermined voltage V_{MAX} and, as a result, charger 300 has transitioned to the CV phase of the charging process. The second condition for EOC detection is that the battery current I_{BAT} has fallen below a predetermined, set level (e.g. 50 mA). When both of these conditions are met, EOC is detected. This bi-condition EOC detection scheme is capable of accurate EOC detection, i.e. determining when battery 310 is fully charged.

The first condition, that is the battery voltage has reached the predetermined voltage V_{MAX}, is detected by CV loop detector 308. In an embodiment, CV loop detector 308 is coupled to the output of the CC loop integrator. As mentioned earlier, as the charging process transitions from the CC phase to the CV phase, the CC loop integrator output has little or no effect on regulator 304. This is mainly because NMOS transistor 338 is pushed into saturation. By setting saturation reference voltage 350 at or near the saturation voltage of transistor 338, detector 308 may accurately determine when the charging process is or has entered the CV phase, i.e. when the CV loop begins to dominate control of regulator 304. If saturation reference voltage 350 is less than the filtered CC loop integrator output, the output of comparator 344 would be logically high, signifying that battery charger 300 is within the CV phase of the charging process. The low-pass filter formed by capacitor 346 and resistor 348 may be used to reduce bounce produced near the CC/CV phase transition boundary. CV loop detector 308 is coupled at an output to EOC detector 312 and signals to EOC detector 312 when the charging process is within the CV phase, the first condition for accurate EOC detection.

In another embodiment, CV loop detector 308 may be coupled to the output of the CV loop integrator. In this instance, saturation reference voltage 350 would be set equal to the predetermined voltage V_{MAX} (e.g. 4.2 V) in which the CV phase of the charging process primarily begins.

Analog-to-digital converter (ADC) 311 is capable of measuring the battery current I_{BAT} using a small sense resistor 316 in series with the negative terminal of battery 310 and ground. The sense resistor 316 is typically very small to reduce the voltage drop across its terminals, which in turn keeps the power dissipation to a minimum. In using sense resistor 316 to detect the battery current I_{BAT}, EOC may be accurately detected. The battery current I_{BAT}, unlike the charging current I_{CHG}, is not dependent on the load current I_{L}. As a result, the battery current I_{BAT} provides a more accurate representation of the charging state of battery 310, regardless of the load current I_{L}. ADC 311 may determine when the battery current I_{BAT} has fallen below the predetermined, set level necessary for EOC detection. ADC 311 is coupled at an output to EOC detector 312 to provide an indication of when the battery current I_{BAT} has fallen below the predetermined, set level.

In another embodiment, ADC 311 may be replaced by a comparator. The comparator may determine when the battery current I_{BAT} has fallen below the set level (e.g. 50 mA) and provide an indication of this to EOC detector 312 via an output signal as shown in FIG. 3.

EOC detector 312 determines that both conditions for EOC are met-battery charger 300 is the CV phase of the charging process, and the battery current I_{BAT} is less than the predetermined, set level. When both of these conditions are met, EOC detector 312 outputs a signal to indicate that the charging process has reached EOC.

### Pulse Charger

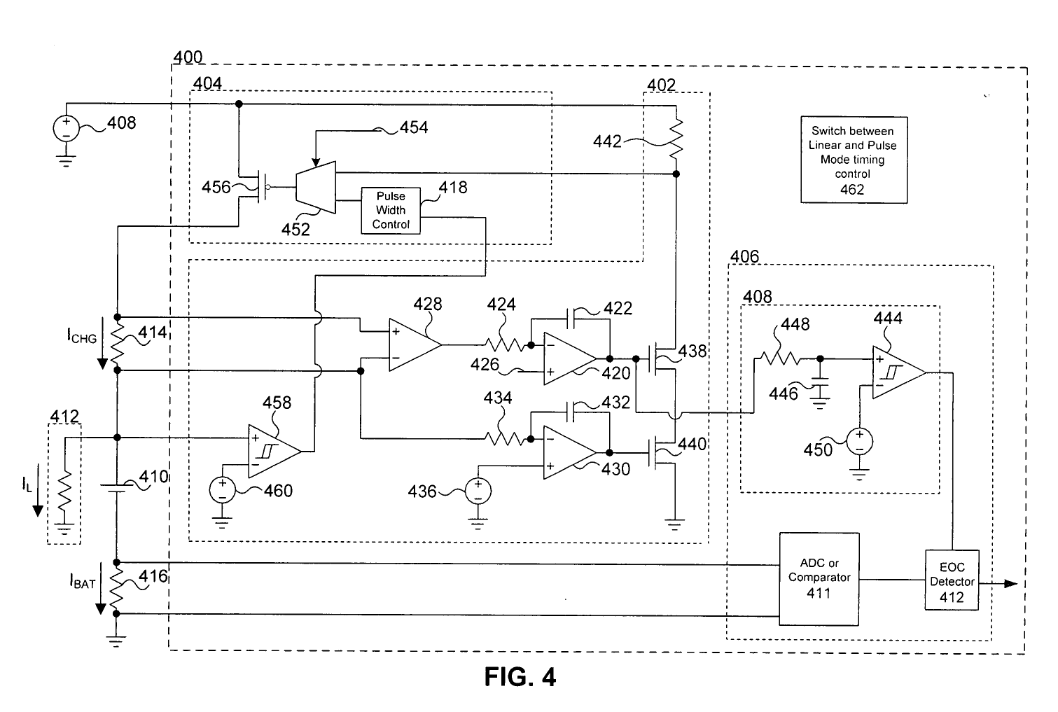

FIG. 4 is a schematic diagram of an exemplary embodiment of a pulse charger 400 in accordance with the present invention. Pulse charger 400 is configured to recharge battery 410 that supplies power to representative load 412. Although simply shown as a resistor, representative load 412 may be a portable communications device or other battery powered device. Pulse charger 400 can monitor and control the charging current/voltage provided to a battery and accurately detect when end-of-charge (EOC) occurs, i.e. when the battery is fully charged.

Pulse charger 400 includes controller 402 that is in communication with regulator 404. Controller 402 controls regulator 404 to supply various levels of charging current I_{CHG} and/or charging voltage to battery 410 during the charging process.

Regulator 404 includes PMOS transistor 456, multiplexer 452, and pulse width control 418. Multiplexer 452 couples one of two distinct control signals to the gate of PMOS transistor 456. The first control signal, coupled to multiplexer 452, is output from pulse width control 418. This first control signal is used by regulator 404 to provide a pulse mode for setting the pulse duty cycle. The second control signal, coupled to multiplexer 452, is derived from one terminal of resistor 442 and the drain of NMOS transistor 438. This second control signal is used by regulator 404 to provide a linear mode for regulating the charging current I_{CHG} and/or the charging voltage. Select signal 454 is controlled by timing control 462 and is operable to select which input to multiplexer 452 is applied to the gate of PMOS transistor 456. In other words, timing control 462 determines if regulator 404 operates in pulse mode or linear mode by controlling select signal 454 of multiplexer 452.

Conventional pulse chargers operate in pulse mode exclusively and generally do not have a linear mode of operation. Pulse charger 400 primarily charges battery 410 in pulse mode and only intermittently switches to the linear mode of operation to determine if EOC has occurred. As will be further explained below, pulse mode is more efficient than the linear mode, having lower power dissipation and faster charging times. However, EOC detection is often difficult while in the pulse mode of operation. Therefore, switching to the linear mode of operation for brief periods of time to determine if EOC has occurred, allows for pulse charger 400 to take advantage of the benefits associated with the pulse mode of operation, while at the same time being capable of accurate EOC detection.

The pulse mode of operation is generally efficient because PMOS transistor 456 is used as a switch. That is, PMOS transistor 456 is controlled to be either fully on or fully off. Controlling the duty cycle in which PMOS transistor 456 is pulsed, allows for the battery to be charged to the final voltage V_{MAX}.

The linear mode of operation is generally less efficient because PMOS transistor 456 is used to drop the adapter voltage down to the battery voltage, dissipating power in the process. PMOS transistor 456 operates primarily in the transistor's linear region of operation and more or less behaves like a variable resistor. Although the linear mode of operation may have disadvantages, it provides a steady charging current I_{CHG}, making EOC detection comparatively more feasible and accurate.

Controller 402 includes two distinct controllers. The first controller is used to control regulator 404 when operating in the pulse charging mode and includes comparator 458 and voltage reference 460. The non-inverting input of comparator 458 is coupled to the top terminal of battery 410 and is used to monitor the charging voltage applied to battery 410. Voltage reference 460 is coupled to the inverting input of comparator 458 and is set to a predetermined value V_{MAX}. The predetermined value V_{MAX} is typically set at or near the voltage rating of the battery (e.g., 4.2 V in common Li-ion batteries). Comparator 458 is used to control pulse width control 418, such that the charging voltage reaches a predetermined value V_{MAX}, and, once the battery voltage reaches V_{MAX}, the battery voltage is maintained at V_{MAX}.

In the beginning of a full charge cycle, when the battery voltage is low, the pulse mode of operation switches PMOS transistor 456 on with a 100% duty cycle (i.e., PMOS transistor remains on). Adapter 408 typically provides a current limited supply of power to battery 410 for constant current (CC) charging. As the battery voltage reaches the predetermined value V_{MAX}, the output of comparator 458 controls pulse width control 418 to adjust the duty cycle of PMOS transistor 456 in order to maintain the charging voltage at V_{MAX} for constant voltage (CV) charging.

Once the battery voltage reaches the predetermined value V_{MAX} using the more efficient pulse mode of operation, pulse charger 400 transitions to the linear mode of operation for a brief time interval, such as 500 ms to determine if EOC has occurred. Because pulse charger 400 only transitions to the linear mode of operation for a brief time, high efficiency is maintained and the temperature of regulator 404 does not significantly increase. After the short time period in which pulse charger 400 is operated in the linear mode of operation, the pulse mode of operation resumes if EOC is not detected. Pulse charging continues for another time period that is typically longer than the time period in which pulse charger 400 operates within the linear mode of operation. For example, pulse charger 400 operates in the pulse charging mode of operation for 15 seconds before transitioning back to the linear mode of operation to determine if EOC has been reached.

The second control unit within Controller 402 is used to control regulator 404 when operating in the linear mode of operation. As shown in FIG. 4, controller 402 further comprises a CC loop integrator and a CV loop integrator that provide an indication of the average charging current I̅_̅{̅C̅H̅G̅}̅ and average charging voltage, respectively. The CC loop integrator includes amplifier 420, capacitor 422, resistor 424, and current setting input 426. The CC loop integrator integrates the charging current I_{CHG} output by differential amplifier 428. Differential amplifier 428 is connected to both terminals of resistor 414. By measuring the voltage drop across resistor 414, the charging current I_{CHG} may be determined by differential amplifier 428. The CC loop integrator integrates the charging current I_{CHG} and adjusts the gate voltage of NMOS transistor 438 to maintain the charging current at a desired level set by current setting input 426. An example voltage applied to current setting input 426 may maintain the charging current I_{CHG} at 100 mA during the CC phase of the charging process, but other voltage values may be applied to current setting input 426 to achieve other constant current values.

The CV loop integrator of controller 402 includes amplifier 430, capacitor 432, resistor 434, and reference voltage 436. The charging voltage is measured from the top terminal of battery 410, which is coupled to the inverting input of amplifier 430 via resistor 434. The CV loop integrator integrates the charging voltage and adjusts the gate voltage of NMOS transistor 440 to maintain the charging voltage at a desired level set by reference voltage 436. An example value for reference voltage 436 may maintain the charging voltage at 4.2 V during the CV phase of the charging process, but other values for reference voltage 436 may be used to achieve other constant charging voltages.

EOC circuit 406 includes CV loop detector 408, analog-to-digital converter 411, and EOC detector 412. CV loop detector 408 includes comparator 444, capacitor 446, resistor 448, and saturation reference voltage 450. Capacitor 446 and resistor 448 form a low-pass filter, the output of which is coupled to the non-inverting input of comparator 444. Saturation reference voltage 450 is coupled to the inverting input of comparator 444.

While in the linear mode of operation, EOC circuit 406 determines that battery 410 has been fully charged when two conditions are met. The first condition for EOC detection is that battery 410 has reached a predetermined voltage V_{MAX} and, as a result, charger 400 has transitioned to the CV phase of the charging process. The second condition for EOC detection is that the battery current I_{BAT} has fallen below a predetermined, set level (e.g. 50 mA). When both of these conditions are met, EOC is detected. This bi-condition EOC detection scheme is capable of accurate EOC detection, i.e. determining when battery 410 is fully charged.

The first condition, that is the battery voltage has reached the predetermined voltage V_{MAX}, is detected by CV loop detector 408. In an embodiment, CV loop detector 408 is coupled to the output of the CC loop integrator. As mentioned earlier (with respect to FIG. 2 and FIG. 3), as the charging process transitions from the CC phase to the CV phase, the CC loop integrator output has little or no effect on regulator 404. This is mainly because NMOS transistor 438 is pushed into saturation. By setting saturation reference voltage 450 at or near the saturation voltage of transistor 438, detector 408 may accurately determine when the charging process is or has entered the CV phase, i.e. when the CV loop begins to dominate control of regulator 404. If saturation reference voltage 450 is less than the filtered CC loop integrator output, the output of comparator 444 would be logically high, signifying that battery charger 400 is within the CV phase of the charging process. The low-pass filter formed by capacitor 446 and resistor 448 may be used to reduce bounce produced near the CC/CV phase transition boundary. CV loop detector 408 is coupled at an output to EOC detector 412 and signals to EOC detector 412 when the charging process is within the CV phase, the first condition for accurate EOC detection.

In another embodiment, CV loop detector 408 may be coupled to the output of the CV loop integrator. In this instance, saturation reference voltage 450 would be set equal to the predetermined voltage V_{MAX} in which the CV phase of the charging process primarily begins.

Analog-to-digital converter (ADC) 411 is capable of measuring the battery current I_{BAT} using a small sense resistor 416 in series with the negative terminal of battery 410 and ground. The sense resistor 416 is typically very small to reduce the voltage drop across its terminals, which in turn keeps the power dissipation to a minimum. In using sense resistor 416 to detect the battery current I_{BAT}, EOC may be accurately detected. The battery current I_{BAT}, unlike the charging current I_{CHG}, is not dependent on the load current I_{L}. As a result, the battery current I_{BAT} provides a more accurate representation of the charging state of battery 410, regardless of the load current I_{L}. ADC 411 may determine when the battery current I_{BAT} has fallen below the predetermined, set level necessary for EOC detection. ADC 411 is coupled at an output to EOC detector 412 to provide an indication of when the battery current I_{BAT} has fallen below the predetermined, set level.

In another embodiment, ADC 411 may be replaced by a comparator. The comparator may determine when the battery current I_{BAT} has fallen below the set level (e.g. 50 mA) and provide an indication of this to EOC detector 412 via an output signal as shown in FIG. 4.

EOC detector 412 determines that both conditions for EOC are met—battery charger 400 is the CV phase of the charging process, and the battery current I_{BAT} is less than the predetermined, set level. When both of these conditions are met, EOC detector 412 outputs a signal to indicate that the charging process has reached EOC.

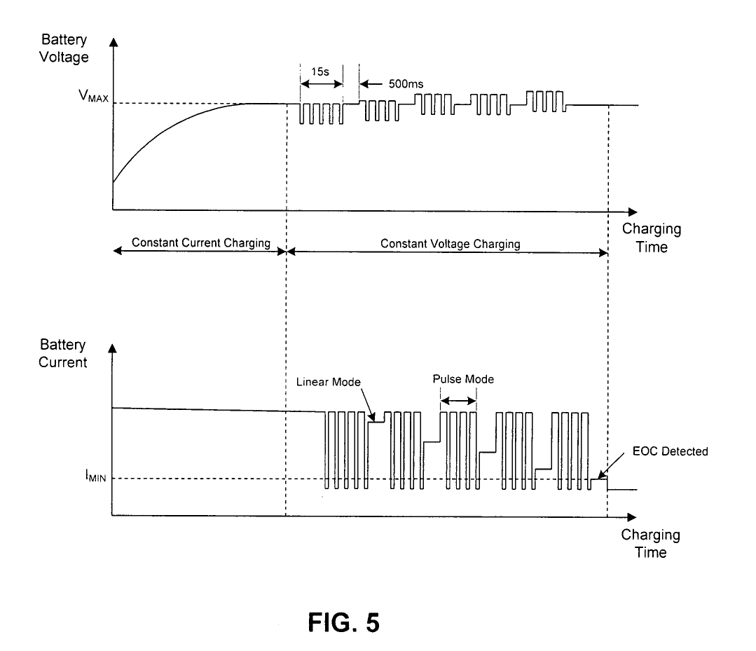

Referring to FIG. 5, an exemplary operation of pulse charger 400 is illustrated. During the constant current phase of the charging process shown in FIG. 5, the battery voltage steadily increases while the charging current I_{CHG} is relatively constant. As the batter voltage reaches the predetermined value V_{MAX}, as shown in FIG. 5, the pulse charger transitions into the CV phase of the charging process, and the battery voltage V_{MAX} is maintained. At this point, the pulse charger switches into a linear mode of operation once the battery voltage reaches V_{MAX} and determines if EOC has been reached. The pulse charger subsequently switches back to the pulse mode of operation if EOC has not been detected within a short duration of time, such as 500 ms as shown in FIG. 5. Pulse mode charging resumes for a certain time duration, for example 15 seconds as shown in FIG. 5, and the charging process continues to switch between pulse mode and linear mode until EOC has been detected. As shown in FIG. 5, EOC is detected while in the CV phase of the charging process and the charging current I_{CHG} has been reduced to a set level, denoted by I_{MIN} in FIG. 5.

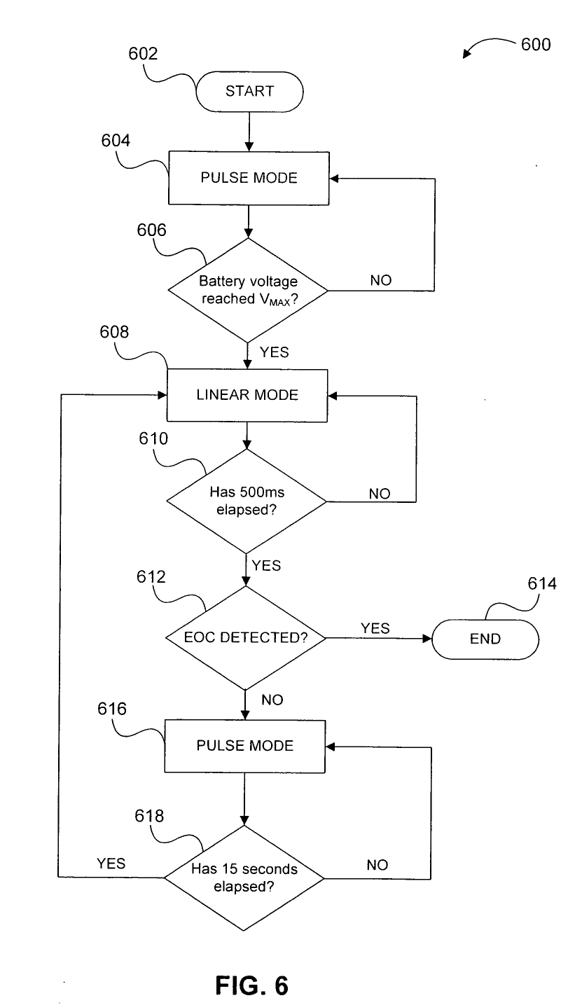

Referring now to FIG. 6, an exemplary flow chart illustrating an embodiment of a charging process 600 for a pulse charger, such as pulse charger 400, is presented. The charging method of FIG. 6 may be used to charge a battery, for example battery 410 of FIG. 4. The charging process begins at step 602. From step 602 the charging process proceeds to step 604 and the pulse charger is placed in a pulse mode. At step 606 it is determined if the battery voltage has reached a predetermined value V_{MAX}, typically set at or near the voltage rating of the battery. If the battery voltage has not yet reached V_{MAX}, charging method 600 continues with the pulse mode at step 604. However, if the battery voltage has reached V_{MAX}, charging process 600 proceeds to step 608 and charging process 600 switches from the pulse mode to a linear mode.

Charging process 600, while in a linear mode of operation, determines at step 610 the duration of time in which charging process 600 has remained in the linear mode compared to a first, predetermined time limit. In charging process 600, an exemplary time limit of 500 ms is implemented. If 500 ms has not yet elapsed, the linear mode continues at step 608. However, after 500 ms has elapsed, charging process 600 transitions to step 612. During step 612, it is determined if EOC has been reached. If EOC has been reached and is detected at step 612, charging process 600 transitions to step 614 and ends. However, if EOC has not yet been reached, charging process 600 proceeds to step to step 616 and the pulse mode resumes. It will be apparent to one skilled in the relevant art(s) that other time limits may be used other than 500 ms at step 610

Charging process 600 proceeds to step 618 and the time in which charging process 600 has been in the pulse mode is compared to a second, predetermined time limit. As shown in charging process 600, this predetermined time limit for pulse charging is set at the exemplary value of 15 seconds. If 15 seconds has not yet elapsed, the pulse mode continues at step 616. However, if charging process 600 has been in the pulse mode for 15 or more seconds, charging process 600 transitions back to the linear mode at step 608. This process continues until EOC has been reached and detected at step 610, at which point charging process 600 transitions to the final step 614.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A battery charger for charging a battery, comprising:
a regulator;
a controller; and
an end-of-charge (EOC) circuit that is configured to detect both a first and a second condition and indicate that EOC has been reached when both the first and second condition are met, wherein the first condition is that a voltage of the battery is being maintained at a predetermined voltage value, and the second condition being that a battery current into the battery is less than a predetermined current value.

2. The battery charger of claim 1, wherein EOC indicates that the battery has been fully charged.

3. The battery charger of claim 1, wherein the predetermined voltage value is the voltage rating of the battery.

4. The battery charger of claim 1, wherein the first condition indicates that the battery charger is in a constant voltage phase.

5. The battery charger of claim 1, wherein the first condition is determined using a comparator.

6. The battery charger of claim 1, wherein the second condition is determined using an analog-to-digital converter or a comparator.

7. The battery charger of claim 1, wherein the battery current into the battery is determined using a sense resistor in series with a negative terminal of the battery and ground.

8. The battery charger of claim 1, wherein the battery charger is a linear charger.

9. The battery charger of claim 1, wherein the battery charger is a switch-mode charger.

10. The battery charger of claim 1, wherein the battery charger is a pulse charger.

11. The battery charger of claim 10, wherein the regulator operates in either a pulse mode or a linear mode.

12. The battery charger of claim 11, wherein the regulator operates in the linear mode to determine if EOC has been reached.

13. A battery charger configured to charge a battery using a constant current phase and a constant voltage phase, comprising:
a regulator;
a controller operable to place the battery charger in a constant current phase and a constant voltage phase; and
an end-of-charge (EOC) circuit that is configured to detect both a first and second condition and indicate that EOC has been reached when both the first and second condition are met, wherein the first condition is that the battery charger is operating within the constant voltage phase, and the second condition being that a battery current into the battery is less than a predetermined current value.

14. The battery charger of claim 13, wherein EOC indicates that the battery has been fully charged.

15. The battery charger of claim 13, wherein the first condition is determined using a comparator.

16. The battery charger of claim 13, wherein the second condition is determined using an analog-to-digital converter or a comparator.

17. The battery charger of claim 13, wherein the battery current into the battery is determined using a sense resistor in series with a negative terminal of the battery and ground.

18. The battery charger of claim 13, wherein the battery charger is a linear charger.

19. The battery charger of claim 13, wherein the battery charger is a switch-mode charger.

20. The battery charger of claim 13, wherein the battery charger is a pulse charger.

21. The battery charger of claim 20, wherein the regulator operates in either a pulse mode or a linear mode.

22. The battery charger of claim 21, wherein the regulator operates in the linear mode to determine if EOC has been reached.

23. A method for charging a battery, comprising:
(a) charging the battery in a pulse mode;
(b) switching to a linear mode once a voltage of the battery reaches a predetermined voltage value;
(c) charging the battery in the linear mode for a first time duration; and
(d) determining if end-of-charge (EOC) has been reached.

24. The method of claim 23, further comprising:
(e) switching to the pulse mode if EOC has not been reached and the first time duration has expired; and
(f) charging the battery in the pulse mode for a second time duration;

25. The method of claim 24, wherein after the second time duration has expired repeating steps (b)-(f) until EOC has been detected.

26. The method of claim 23, wherein EOC indicates that the battery has been fully charged.

27. The method of claim 23, wherein the predetermined voltage value is the voltage rating of the battery.

28. The method of claim 23, wherein EOC is determined when both a first and second condition are true, wherein the first condition is that a voltage of the battery is being maintained at the predetermined voltage value, and the second condition being that a battery current into the battery is less than a predetermined current value.
